(19) United States
(12) Patent Application Publication
(10) Pub. No.: US 2024/0046874 A1
(43) Pub. Date: Feb. 8, 2024

(54) Compensating for Voltage Losses in OLED Displays

(71) Applicant: Google LLC, Mountain View, CA (US)

(72) Inventors: XiaoPing Bai, Pleasanton, CA (US); Chien-Hui Wen, Cupertino, CA (US); Ken Kok Foo, Sunnyvale, CA (US)

(73) Assignee: Google LLC, Mountain View, CA (US)

(21) Appl. No.: 18/488,742

(22) Filed: Oct. 17, 2023

Related U.S. Application Data
(60) Provisional application No. 63/590,251, filed on Oct. 13, 2023.

(51) Int. Cl. G09G 3/3233

(52) U.S. Cl. CPC G09G 3/3233; G09G 2320/0233; G09G 2320/0285; G09G 2330/021

(57) ABSTRACT

This document describes systems and techniques directed at compensating for voltage losses in organic light-emitting diode (OLED) displays. In aspects, a computing device having an OLED display and a luminance manager is configured to receive an indication of a luminance that is, or is intended to be, displayed by pixels of the OLED display. Responsive to and based on the received indication of luminance and a voltage loss, the luminance manager determines a luminance modification for the pixels of the OLED display. Based on the determined luminance modification, the luminance manager modifies the luminance that is displayed or modifies the luminance that is intended to be displayed by the pixels of the OLED display effective to compensate for the voltage loss.

### CROSS-REFERENCE TO RELATED APPLICATION(S)

This application claims priority to U.S. Provisional Application Ser. No. 63/590,251, filed Oct. 13, 2023, the disclosure of which is incorporated herein by reference in its entirety.

### SUMMARY

This document describes systems and techniques directed at compensating for voltage losses in organic light-emitting diode (OLED) displays. In aspects, a computing device having an OLED display and a luminance manager is configured to receive an indication of a luminance that is, or is intended to be, displayed by pixels of the OLED display. Responsive to and based on the received indication of luminance and a voltage loss, the luminance manager determines a luminance modification for the pixels of the OLED display. Based on the determined luminance modification, the luminance manager modifies the luminance that is displayed or modifies the luminance that is intended to be displayed by pixels of the OLED display effective to compensate for the voltage loss.

In some aspects, a method is disclosed for compensating for voltage losses in OLED displays. The method includes receiving an indication of a luminance that is intended to be displayed by pixels of an OLED display. For example, an OLED display may be enclosed in a housing of a smartphone, realized as a television, or implemented as a computer monitor. The method further includes receiving an unintended luminance characteristic associated with the OLED display and determining, based on the received indication of the luminance and the unintended luminance characteristic associated with the OLED display, a luminance modification for the pixels of the OLED display. As an example, the unintended luminance characteristic may include a solid white image that is dimmer than intended that results from a voltage loss (e.g., current-resistance loss, IR loss) from driving the pixels of the OLED display to display white. As another example, the unintended luminance characteristic may include a gradient image (e.g., white, black, and gray) whose white pixels are brighter than intended that results from over-compensating for a voltage loss in the pixels displaying white. In addition, the method includes causing the luminance modification to the pixels of the OLED display, the causing modifying the luminance that is intended to be displayed effective to compensate for the unintended luminance characteristic associated with the OLED display.

In further aspects, a computing device is disclosed. The computing device includes an OLED display, one or more processors, and memory. The memory may store instructions that, when executed by the one or more processors, cause the one or more processors to implement a luminance manager effective to compensate for unintended luminance characteristics in OLED display applications by performing the method above.

This Summary is provided to introduce simplified concepts of compensating for voltage losses in OLED displays, which are further described in the Detailed Description and are illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of compensating for voltage losses in OLED displays are described in this document with reference to the following drawings:

FIG. 1 illustrates an example implementation of an inner portion and an outer portion of an OLED display;

FIG. 2 illustrates various example implementations of an OLED display emitting various gray levels from an inner portion and an outer portion of the OLED display;

FIG. 3 illustrates an example computing device having an OLED display and a luminance manager configured to compensate for voltage loss in the OLED display;

FIG. 4 illustrates an example implementation of a display driver integrated circuit (DDIC) structure for a single on-pixel-ratio (OPR) luminance set;

FIG. 5 illustrates an example implementation of a DDIC structure for a discrete OP luminance set; and

FIG. 6 illustrates an example method for compensating for voltage losses in an OLED display.

### DETAILED DESCRIPTION

Overview

Computing device users have become accustomed to a variety of features offered by a computing device. For example, smartphone users may have become accustomed to bright (e.g., 1,500 nits peak) and responsive (e.g., 90 hertz refresh rate) displays. Therefore, for smartphones to be competitive in a smartphone market, many smartphones may include an OLED display capable of such brightness and a touchscreen capable of such responsiveness. As another example, smartphone users may have become accustomed to displays that emit accurate colors. Therefore, for smartphones to be even more competitive in the smartphone market, many smartphones include color-accurate displays. To achieve such color accuracy, a smartphone manufacturer may calibrate displays for color accuracy, which includes calibrating gamma, a mathematical formula for converting stored luminance (e.g., brightness) values to raw light intensity values (e.g., voltages to pixels of an OLED display).

In some implementations, however, a manufacturer may calibrate gamma in a suboptimal manner. As an example, a manufacturer may calibrate gamma by measuring a luminance at various gray levels using an on-axis sensor (e.g., a camera) oriented toward a center of a plane of a main portion of an OLED display. The gray levels may include gray 0 (e.g., black), gray 255 (e.g., white), and a variety of gray levels in between (e.g., gray 127, gray 63). The gray levels may correspond to on-pixel-ratios (OPRs), which describe a ratio of pixels at a first gray level to pixels of a second gray level and are measured from 0 to 100. For example, an OPR of 0 describes the OLED display when the pixels emit gray 0, an OPR of 100 describes the OLED display when the pixels emit gray 255, and an OPR of 50 describes the OLED display when the pixels emit gray 127.

Unfortunately, a driving voltage (e.g., from a DDIC) of the pixels of the OLED display may suffer from losses corresponding to various OPRs. A minimum voltage loss may correspond to an OPR of 0 while a maximum voltage loss may correspond to an OPR of 100. Accordingly, a smartphone manufacturer may increase the driving voltage of the pixels of the OLED display as the OPR approaches 100 and for pixels that emit larger gray levels (e.g., gray 200, gray 255). However, for on-screen content (e.g., photos, videos) that includes a mixture of gray levels (e.g., OPRs less than 100), the pixels that emit larger gray levels may be overdriven, resulting in those pixels being too bright, sacrificing color and gamma accuracy.

Alternatively, this document describes methods implemented by and systems effective to compensate for voltage losses in OLED displays. In aspects, compensating for voltage losses in OLED displays may include calibrating color and gamma by measuring the luminance of the OLED displays while pixels of the displays emit a constant OPR. The constant OPR may be determined by a manufacturer of the OLED displays based on a typical use case. Additionally or alternatively, various OPRs may be used by the manufacturer to calibrate the OLED display. The relationship between measured luminance at the constant and/or various OPRs and an intended luminance may be saved in a lookup table (LUT). The LUT may be referenced by smartphones to adjust a driving voltage of the pixels accordingly. By so doing, compensating for voltage losses in OLED displays as described herein alleviates the issues of overdriven, bright pixels and color and gamma inaccuracies described above.

### Example Implementations

The following discussion describes example implementations, techniques, apparatuses that may be employed in the example implementations, and various devices in which components of compensating for voltage losses in OLED displays can be embodied. In the context of the present document, reference is made to the following by way of example only.

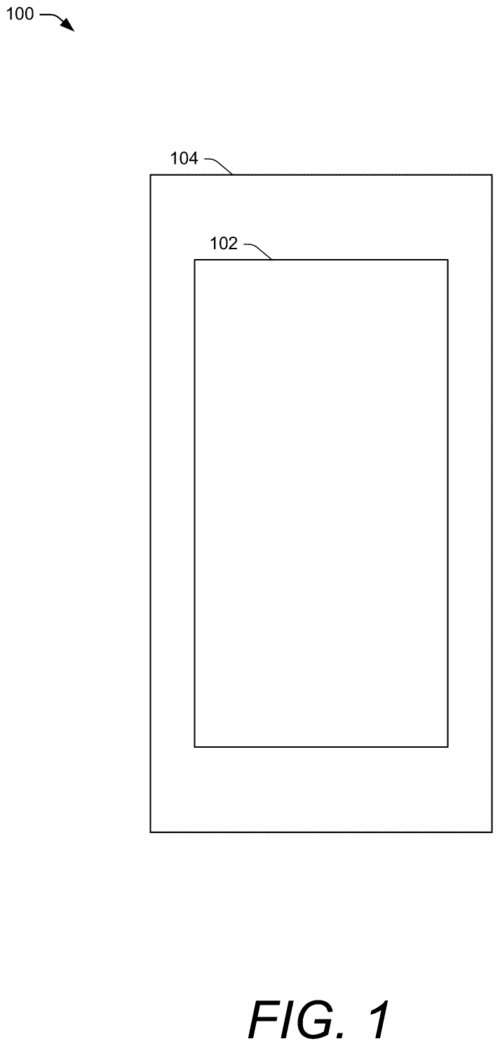

FIG. 1 illustrates an example implementation of an inner portion 102 and an outer portion 104 of an OLED display 100. The inner portion 102 and the outer portion 104 of the OLED display 100 may consist of a number of pixels. The number of pixels for the inner portion 102 and the outer portion 104 may be a same number of pixels (e.g., 50 percent of total pixels) or a different number of pixels (e.g., a 60/40 split). Further, the inner portion 102 and the outer portion 104 of the OLED display 100 may emit gray levels during a color calibration procedure in a manufacturing pipeline. The number of pixels and the gray levels for the inner portion 102 and the outer portion 104 of the OLED display 100 may be configured to achieve a certain OPR.

An OPR describes a ratio of a sum of gray values for each on-pixel compared to a value when all pixels emit gray 255 (e.g., white). The OPR comprises values from zero to 100, where an OPR of zero describes a display where all pixels emit gray 0 (e.g., black) and an OPR of 100 describes a display where all pixels emit gray 255 (e.g., white). For example, an OPR of 50 may describe a display where 50 percent of the pixels emit gray 0 and 50 percent of the pixels emit gray 255. As another example, an OPR of 50 may describe a display where all pixels emit gray 127.

The certain OPR may be determined by a manufacturer of the OLED display 100 based on a typical use case scenario. As an example, the manufacturer of the OLED display 100 may determine that the OPR is 60 in a typical use case scenario. To achieve this OPR of 60, the manufacturer may configure the inner portion 102 of the OLED display 100 to comprise 60 percent of total pixels and the outer portion 104 to comprise 40 percent of the total pixels. Furthermore, the manufacturer may, during the color calibration procedure, configure the inner portion 102 of the OLED display to emit gray 255 (e.g., white) and the outer portion 104 to emit gray 0 (e.g., black). Thus, 60 percent of the pixels of the OLED display 100 emit gray 255 and 40 percent of the pixels of the OLED display emit gray 0, thus achieving the OPR of 60.

The manufacturer may utilize various OPRs during the color calibration process in the manufacturing pipeline to represent various use cases. The manufacturer may measure a luminance of pixels of the inner portion 102 of the display 100 using an on-axis sensor (e.g., a camera) oriented toward a center of a plane of the inner portion 102. The manufacturer may repeat this measurement process for various OPRs and various luminance values (e.g., brightness values, light intensity values) and gray levels. The manufacturer may build a LUT, or other appropriate correlation tool, that relates the measured luminance to an intended luminance for the pixels of the OLED display 100.

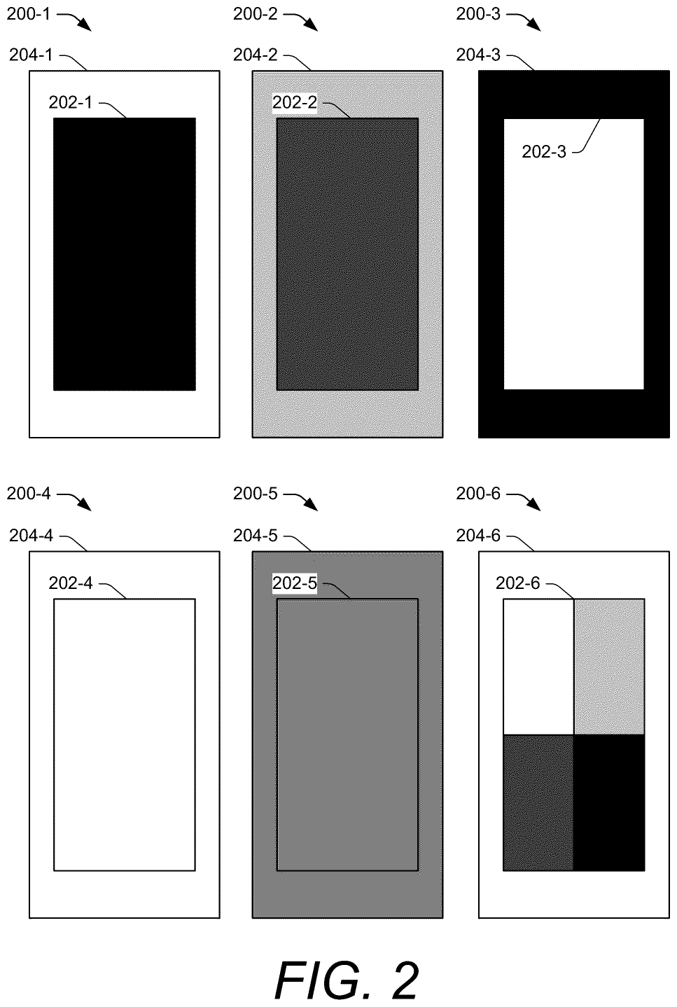

FIG. 2 illustrates various example implementations of an OLED display 200 (e.g., OLED display 100 of FIG. 1) emitting various gray levels from an inner portion 202 and an outer portion 204 of the OLED display 200. In the various example implementations 200, the inner portion 202 and the outer portion 204 of the OLED display 200 may include a same number of pixels for the purpose of clarity. Although the various example implementations 200 are described as having the inner portion 202 and the outer portion 204 equal in numbers of pixels, they are provided as examples only. The numbers of pixels of the inner portion 202 and the outer portion 204 may be equal or unequal, depending on a design consideration of a manufacturer of the OLED display 200.

As illustrated, the example implementations of the OLED display 200 include a first OLED display 200-1, a second OLED display 200-2, a third OLED display 200-3, a fourth OLED display 200-4, a fifth OLED display 200-5, and a sixth OLED display 200-6. Each of the OLED displays 200 includes an inner portion 202 and an outer portion 204. Further, each of the inner portions 202 and the outer portions 204 are illustrated emitting various gray levels, which a manufacturer may use during a color calibration process in a manufacturing pipeline to build a LUT, like that described above.

The inner portion 202-1 of the first OLED display 200-1 may emit gray 0 and the outer portion 204-1 may emit gray 255. Given that the inner portion 202-1 and the outer portion 204-1 include a same number of pixels, this configuration achieves an OPR of 50. The inner portion 202-2 of the second OLED display 200-2 may emit gray 63 and the outer portion 204-2 may emit gray 191. Given that the inner portion 202-2 and the outer portion 204-2 include a same number of pixels in this example, this also achieves an OPR of 50. The inner portion 202-3 of the third OLED display 200-3 may emit gray 255 and the outer portion 204-3 may emit gray 0. Given that the inner portion 202-3 and the outer portion 204-3 include a same number of pixels, this third configuration also achieves an OPR of 50.

FIG. 2 further illustrates that the inner portions 202 and the outer portions 204 of the fourth OLED display 200-4 and the fifth OLED display 200-5 emit a same gray color. The inner portion 202-4 and the outer portion 204-4 of the fourth OLED display 200-4 emit gray 255 for an OPR of 100. The inner portion 202-5 and the outer portion 204-5 of the fifth display 200-5 emit gray 127 for an OPR of 50. Lastly, FIG. 2 illustrates in the sixth OLED display 200-6 that the inner portion 202-6 can emit multiple gray levels. Multiple gray levels emitted by an inner portion of a single OLED display may be used by a manufacturer of the single OLED display to measure multiple luminance values simultaneously (e.g., via multiple on-axis sensors) to, for example, reduce a time to market. In this example, the inner portion 202-6 of the sixth OLED display 200-6 includes four equal portions that each emit a unique gray color, including gray 255 (upper left), gray 191 (upper right), gray 63 (bottom left), and gray 0 (bottom right). This configuration achieves an OPR of 75.

As an example, a manufacturer of OLED displays may generate a number of gray levels (e.g., images) to be emitted by an OLED display. The images may include various gray levels emitted by an inner portion and an outer portion of the OLED display. The images may include a same, constant OPR that is representative of a typical use case. The manufacturer may measure a luminance via an on-axis sensor oriented toward a center of a plane of the inner portion of the OLED display. Based on a gamma tuning requirement, the manufacturer may interpolate measured luminance data to generate a gamma tuning curve with the constant OPR. The manufacturer may store the gamma tuning curve as a function or LUT, for example, on a memory of a computing device having the OLED display.

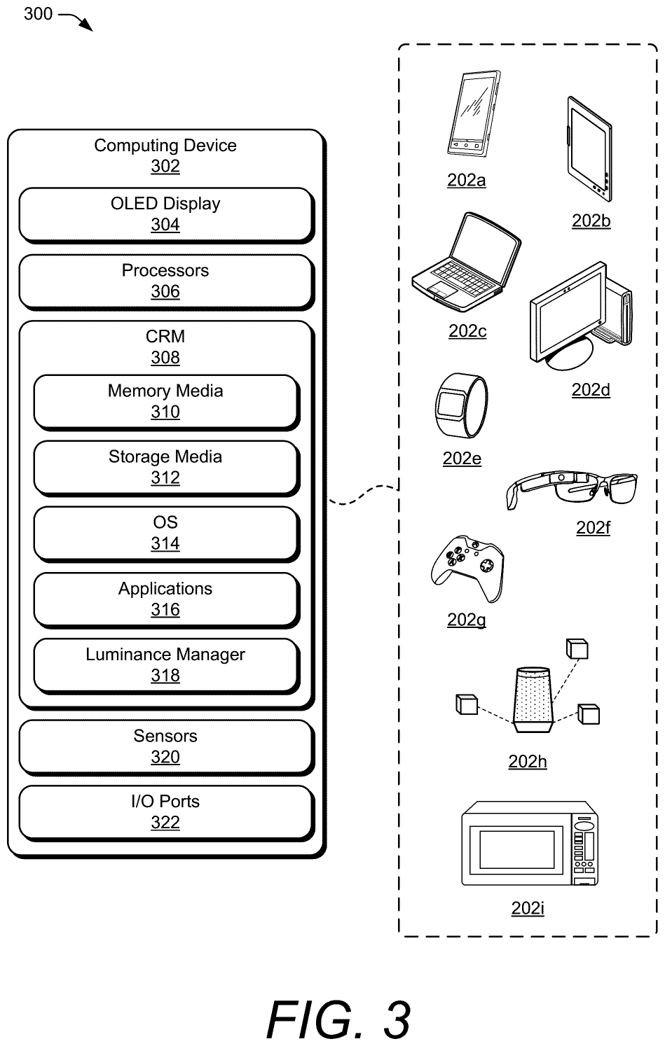

FIG. 3 illustrates, at 300 generally, an example computing device 302 having an OLED display 304 and a luminance manager 318 configured to compensate for voltage losses in the OLED display 304. As non-limiting examples, the computing device 302 is illustrated as various computing devices, including a smartphone 202a, a tablet 202b, a laptop 202c, a desktop 202d, a smartwatch 202e, a pair of smart glasses 202f, a game controller 202g, a smart home speaker 202h, and a microwave 202i. Although not illustrated, the computing device 302 may also be implemented as an audio recording device, a home automation system, a drone, and so forth. The computing device 302 can be wearable, non-wearable but mobile, or relatively immobile (e.g., the desktop 202d). The computing device 302 may be used with, or embedded within, many computing devices 302 or peripherals, such as in automotive vehicles or as an attachment to a personal computer.

As illustrated, the computing device 302 includes the OLED display 304 (e.g., OLED display 100 of FIG. 1, OLED displays 200 of FIG. 2), one or more processors 306, and computer-readable media 308 (CRM 308). The OLED display 304 may be enclosed in a housing (not illustrated) of the computing device 302, be rectangular in shape, and include a number of pixels. For example, the rectangular OLED display 304 may include 1,080 pixels on a short side of the rectangle and 1,920 pixels on a long side of the rectangle. Although not described, the OLED display 304 may be any shape, including a rectangle as mentioned, a square, a circle (e.g., in the smartwatch 202e), and so forth.

The pixels of the OLED display 304 may include red, green, and blue (RGB) sub-pixels. The pixels and the sub-pixels thereof may operate based on a driving voltage (e.g., 1.2 volts (V)) provided by a DDIC (not illustrated). The DDIC may be included as a component of the OLED display 304 or a separate component operably coupled to the OLED display 304.

The processors 306 may include any appropriate single-core or multi-core processors, including central processing units (CPUs), graphics processing units (GPUs), systems-on-a-chip (SoCs), and so forth. The processors 306 may also be realized as reduced instruction set compute (RISC) SoCs, advanced RISC machine (ARM) SoCs, arithmetic logic units (ALUs), and the like. The processors 306 may further be single-threaded or multi-threaded SoCs.

FIG. 3 further illustrates that the CRM 308 includes memory media 310 and storage media 312. The memory media 310 may include any one or more appropriate transitory storage devices, including dynamic random-access memory (DRAM), which may be implemented as a dual inline memory module (DIMM) or a small outline DIMM (SODIMM). The storage media 312 may include any one or more appropriate non-transitory storage devices, including magnetic spinning hard drive disks (HDDs) and solid state drives (SSDs). The CRM 308 also includes an operating system 314 (OS 314), applications 316, and the luminance manager 318, which is configured to compensate for voltage losses in OLED displays. The OS 314, the applications 316, and the luminance manager 318 may be stored as computer-readable instructions on the memory media 310 and/or the storage media 312. The processors 306 may execute these computer-readable instructions to provide some or all of the functionalities described herein.

As illustrated, the computing device further includes one or more sensors 320 and input/output ports 322 (I/O ports 322). The sensors 320 may include any one or more of a variety of sensors, including accelerometers, image sensors (e.g., cameras), ambient light sensors, touch sensors (e.g., a touch screen), and so forth. The I/O ports 322 may include any one or more of a variety of ports, including universal serial bus (USB) ports, auxiliary ports (e.g., headphone jacks), secure digital (SD) ports, micro-SD ports, and the like.

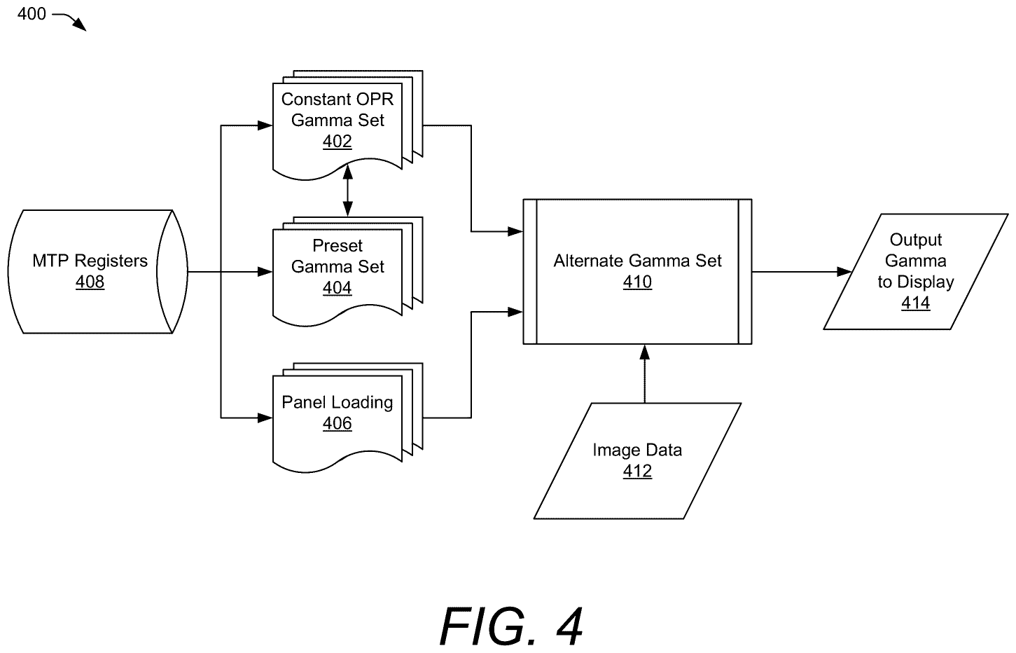

FIG. 4 illustrates an example implementation 400 of a DDIC structure for a constant OPR gamma set 402. The DDIC structure may include hardware components and software components of a computing device (e.g., computing device 302 of FIG. 3). The computing device may include, although not illustrated, an OLED display (e.g., OLED display 100 of FIG. 1). The DDIC structure may be managed by a luminance manager (e.g., luminance manager 318 of FIG. 3) of the computing device.

As illustrated, the example implementation 400 of the DDIC structure includes the constant OPR gamma set 402, which may be realized as a gamma tuning curve (e.g., a mathematical function), LUT, or other appropriate data set stored on a memory (e.g., CRM 308) of the computing device. In this example, the constant OPR gamma set 402 may be stored in multiple time program registers 408 (MTP registers 408). The constant OPR gamma set 402 may be tuned by a manufacturer of the computing device using a constant OPR of 50, 40, 74, and so forth.

To display an image, the computing device including the DDIC structure of FIG. 4 may receive image data 412 from an SoC or processor (e.g., processors 306). Based on the received image data 412, the luminance manager may calculate an OPR to determine a driving voltage for pixels of the OLED display. The determined driving voltage may further be based on the constant OPR gamma set 402, preset gamma sets 404, and panel loading 406 (e.g., of the OLED display). The panel loading 406 may include voltage losses based on the calculated OPR of the received image data 412. The luminance manager may generate an alternate gamma set 410 based on the constant OPR gamma set 402, the panel loading 406, and the image data 412. Utilizing the alternate gamma set 410, the luminance manager may, at 414, output the alternate gamma set 410 to the OLED display. By so doing, the luminance manager is effective to compensate for voltage losses in the OLED display based on the panel loading 406 of the image data 412.

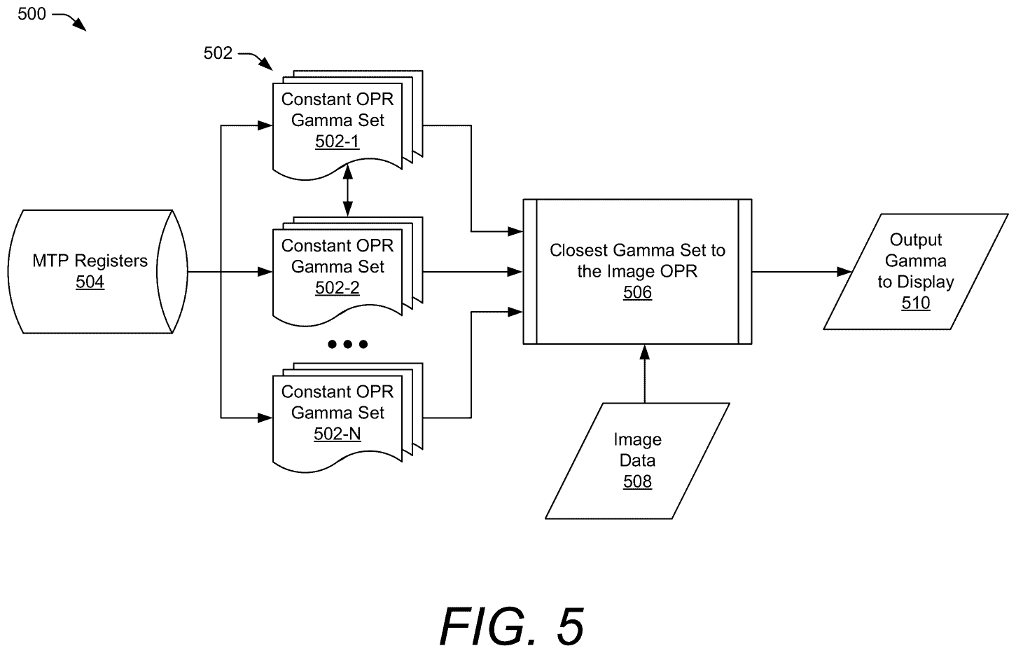

FIG. 5 illustrates an example implementation 500 of a DDIC structure for multiple OPR gamma sets 502. The DDIC structure for the various multiple gamma sets 502 is similar to the DDIC structure for the constant OPR gamma set 402 of FIG. 4 except as detailed below. Thus the DDIC structure for the multiple gamma sets 502 may be managed by a luminance manager and include hardware and software components of a computing device. Further, the DDIC structure for the multiple gamma sets 502 includes MTP registers 504, image data 508, and a luminance manager (not illustrated) that may, at 510, output a gamma set to an OLED display of the computing device. The MTP registers 504 may store the various multiple gamma sets 502 as, for example, gamma curve functions or LUTs.

As illustrated, the various multiple gamma sets 502 include a first constant OPR gamma set 502-1, a second constant OPR gamma set 502-2, and an Nth constant OPR gamma set 502-N. N may be any positive integer, including three, four, 10, 13, and so forth. The exact integer value of N may depend on design considerations of a manufacturer of the computing device. The various multiple gamma sets 502 may be stored in the MTP registers 504 or another appropriate memory of the computing device.

The manufacturer of the computing device having the DDIC structure for the multiple gamma sets 502 may tune each individual gamma set using any one of a variety of OPRs. For example, the manufacturer may tune the first constant OPR gamma set 502-1 using an OPR of 40, the second constant OPR gamma set 502-2 using an OPR of 60, and the Nth constant OPR gamma set using an OPR of 70.

To emit an image using the OLED display of the computing device, the luminance manager may receive the image data 508 from a memory or SoC of the computing device. Additionally, the luminance manager may receive the first through the Nth constant OPR gamma sets 502. Based on the image data 508 and the first through the Nth constant OPR gamma sets 502, the luminance manager may select, at 506, a gamma set associated with an OPR of the image. The image OPR may be included in the image data 508. Additionally or alternatively, if the selected gamma set is not included in the various multiple OPR gamma sets 502, the luminance manager may interpolate the various multiple OPR gamma sets 502 to determine an OPR that is associated with the image OPR.

Based on the selected or determined OPR that is associated with the image OPR, the luminance manager may direct the DDIC to adjust a driving voltage for pixels of the OLED display. For example, if the image-associated OPR is relatively high (e.g., 70, 80, 90, 100), then the luminance manager may direct the DDIC to increase the driving voltage. As another example, if the image-associated OPR is relatively low (e.g., 10, 20), then the luminance manager may direct the DDIC to not adjust the driving voltage or even decrease the driving voltage. By so doing, the luminance manager is effective to compensate for voltage losses, or lack thereof, in the OLED display.

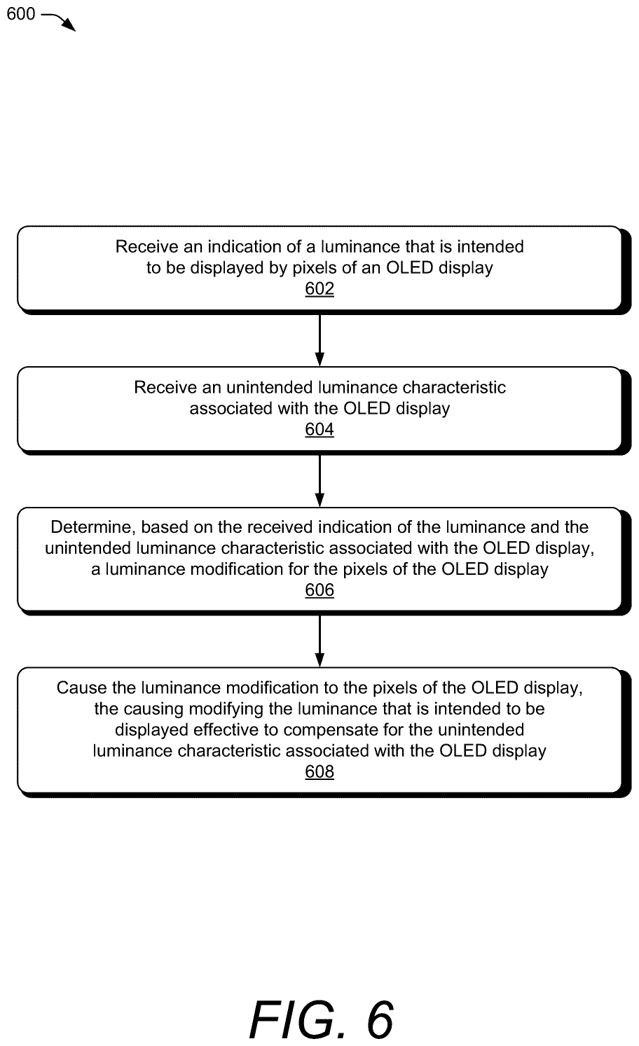

FIG. 6 illustrates an example method 600 for compensating for voltage losses in an OLED display (e.g., OLED display 100 of FIG. 1, OLED display 304 of FIG. 3). The method 600 may be implemented by a luminance manager (e.g., luminance manager 318 of FIG. 3) of a computing device (e.g., computing device 302 of FIG. 3). The luminance manager may be stored on memory (e.g., CRM 308) as computer-readable instructions and executed by a processor (e.g., processors 306).

At 602, the luminance manager receives an indication of a luminance that is intended to be displayed by pixels of an OLED display. The indication of the luminance that is intended to be displayed may be included in image data from memory or a DDIC of a computing device. The image data may include gray level and luminance information.

At 604, the luminance manager receives an unintended luminance characteristic associated with the OLED display. The unintended luminance characteristic may be a luminance that is higher or lower than the indication of the luminance that is intended to be displayed. The unintended luminance characteristic may be a luminance that is lower than intended as a result of a voltage loss in the OLED display. This may occur when an image OPR is relatively high (e.g., 85, 95). Additionally or alternatively, the unintended luminance characteristic may be a luminance that is higher than intended as a result of relatively low voltage loss in the OLED display. This may occur when an image OPR is relatively low (e.g., 5, 15).

At 606, the luminance manager determines, based on the received indication of the luminance and the unintended luminance characteristic associated with the OLED display, a luminance modification for the pixels of the OLED display. The luminance modification may include a driving voltage increase for the pixels of the OLED display. The luminance modification may be determined by the luminance manager by referencing OPR gamma sets that are stored in memory like the examples described with reference to FIGS. 4 and/or 5.

At 608, the luminance manager causes the luminance modification to the pixels of the OLED display, the causing modifying the luminance that is intended to be displayed effective to compensate for the unintended luminance characteristic associated with the OLED display. The luminance manager may cause the luminance modification by directing a DDIC associated with the OLED display to increase, or decrease, an output voltage. The output voltage of the DDIC may be a driving voltage for the pixels of the OLED display.

### CONCLUSION

Although concepts of techniques and apparatuses directed to compensating for voltage losses in OLED displays have been described in language specific to techniques and/or apparatuses, it is to be understood that the subject of the appended claims is not necessarily limited to the specific techniques or apparatuses described. Rather, the specific techniques and apparatuses are disclosed as example implementations of compensating for voltage losses in OLED displays.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

What is claimed is:

1. A method comprising:
receiving an indication of a luminance that is intended to be displayed by pixels of an organic light-emitting diode (OLED) display;
receiving an unintended luminance characteristic associated with the OLED display;
determining, based on the received indication of the luminance and the unintended luminance characteristic associated with the OLED display, a luminance modification for the pixels of the OLED display; and
causing the luminance modification to the pixels of the OLED display, the causing modifying the luminance that is intended to be displayed effective to compensate for the unintended luminance characteristic associated with the OLED display.

2. The method of claim 1, wherein determining the luminance modification uses a lookup table correlating the indication of the luminance with the luminance modification.

3. The method of claim 1, wherein the unintended luminance characteristic associated with the OLED display is determined based on a reception of luminance of an on-axis sensor, the on-axis sensor oriented toward a center of a plane of a main portion of the OLED display.

4. The method of claim 3, wherein:
an inner portion of the main portion of the OLED display emits a first gray level;
an outer portion of the main portion of the OLED display emits a second gray level; and
the first gray level and the second gray level achieve an on-pixel-ratio.

5. The method of claim 4, wherein:
the inner portion of the main portion of the OLED display emits a third gray level different than the first gray level and the second gray level;
the outer portion of the main portion of the OLED display emits a fourth gray level different than the first gray level and the second gray level; and
the third gray level and the fourth gray level achieve the on-pixel-ratio.

6. The method of claim 1, wherein modifying the luminance that is intended to be displayed includes modifying an input voltage to the OLED display.

7. The method of claim 6, wherein modifying the input voltage to the OLED display comprises at least one of:
modifying an output voltage of a display driver integrated circuit; or
modifying an output voltage of a power management integrated circuit.

8. The method of claim 1, wherein the unintended luminance characteristic is associated with a voltage loss in the OLED display.

9. The method of claim 1, wherein causing the luminance modification to the pixels of the OLED display uses a gamma function to convert the luminance modification to a light intensity value.

10. A computing device comprising:
an organic light-emitting diode (OLED) display;
one or more processors; and
memory storing:
instructions that, when executed by the one or more processors, cause the one or more processors to implement a luminance manager effective to provide compensation for unintended luminance characteristics associated with voltage losses of the OLED display.
